(19) United States
(12) Patent Application Publication
(10) Pub. No.: US 2021/0183335 A1
(43) Pub. Date: Jun. 17, 2021

(54) METHOD FOR CONTROLLING INFORMATION DISPLAY AND DEVICE THEREOF

(71) Applicant: WUHAN CHINA STAR OPTOELECTRONICS SEMICONDUCTOR DISPLAY TECHNOLOGY CO., LTD., Wuhan (CN)

(72) Inventor: Yuelong SONG, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/342,210

(22) PCT Filed: Jan. 9, 2019
(86) PCT No.: PCT/CN2019/071022

§ 371 Date: Apr. 16, 2019

(30) Foreign Application Priority Data
Dec. 5, 2018 (CN) 201811481210.1

(51) Int. Cl. G09G 5/14; G06F 3/0486; G06F 3/0484; G06F 1/3234

(52) U.S. Cl. CPC G09G 5/14; G06F 3/0486; G06F 3/04847; G09G 3/3208; G06F 1/3265; G06F 2203/04803; G06F 3/04845

(57) ABSTRACT

A method for controlling information display is provided. The method comprises the steps of setting a plurality of information display regions on a display screen of an electronic device; dragging at least one software to the plurality of information display regions; storing information type of the least one software in the electronic device, and the information type of the at least one software corresponds to the at least one information display region; receiving information in connection with the at least one software by a controller; and displaying the information in connection with the at least one software at the at least one information display region. Accordingly, pieces of information in connection with the at least one software are respectively displayed at the at least one information display region so as to reduce power consumption.

### BACKGROUND OF INVENTION

### Field of Invention

The present invention relates to a technical field of information display and particularly a method for controlling software information display and device thereof.

### Description of Prior Art

When a terminal of a current electronic devices is locked, the terminal receives software information and a display screen of the entire electronic device is illuminated, resulting in waste of power. Therefore, it is necessary to provide a control method for energy saving and power saving to solve problems existing in the prior art.

### SUMMARY OF INVENTION

In one embodiment, a method for controlling information display is provided. In particular, a method for controlling information display on a display screen of an electronic device is provided for energy saving.

According to one embodiment of the present invention, a method for controlling information display comprises setting at least one information display region on a display screen of an electronic device; dragging at least one software to the at least one information display region; storing one information type of the at least one software in the electronic device, and the information type of the at least one software corresponds to the at least one information display region; receiving information in connection with the at least one software by a controller; and displaying the information in connection with the at least one software in the at least one information display region.

In one embodiment of the present invention, the method comprises continuously double-clicking on the display screen of the electronic device to enter a setting mode.

In one embodiment of the present invention, the method comprises adjusting a border of the at least one information display region.

In one embodiment of the present invention, an area of the at least one information display region is less than an area of the display screen of the electronic device.

In one embodiment of the present invention, the area of the at least one information display region is constant.

In one embodiment of the present invention, the area of the at least one information display region is adjustable.

In one embodiment of the present invention, the display screen of the electronic device comprises one of an organic light-emitting diode and a light-emitting diode.

In one embodiment of the present invention, the controller is a central processing unit.

In one embodiment of the present invention, the information type of the at least one software comprises one of a text message and a video message.

In one embodiment of the present invention, there are more than one pieces of information and more than one information display regions, and the pieces of information are simultaneously displayed at the information display regions, respectively, at the same time.

In one embodiment of the present invention, there are more than one pieces of information and more than one information display regions, and the pieces of information are displayed at the information display regions, respectively, at different times.

According to one embodiment of the present invention, an electronic device for displaying information comprises a display screen, wherein at least one information display region is set on the display screen, and at least one software is dragged to the at least one information display region; and a controller, wherein information in connection with the at least one software is received by the controller, and the information in connection with the at least one software is displayed at the at least one information display region.

In one embodiment of the present invention, continuously double-clicking on the display screen of the electronic device to enter a setting mode.

In one embodiment of the present invention, an area of the at least one information display region is less than an area of the display screen of the electronic device.

In one embodiment of the present invention, the area of the at least one information display region is constant.

In one embodiment of the present invention, the area of the at least one information display region is adjustable.

In one embodiment of the present invention, the display screen of the electronic device comprises one of an organic light-emitting diode and a light-emitting diode.

In one embodiment of the present invention, the at least one software information type comprises one of a text message and a video message.

In one embodiment of the present invention, there are more than one pieces of information and more than one information display regions, and the pieces of information are simultaneously displayed at the information display regions, respectively, at the same time.

In one embodiment of the present invention, t there are more than one pieces of information and more than one information display regions, and the pieces of information are displayed at the information display regions, respectively, at different times.

As compared with prior art, a method for controlling information display provided by the present invention can reduce power consumption through displaying pieces of information in connection with software at the information display region, respectively.

### BRIEF DESCRIPTION OF DRAWINGS

FIG. 1 is a schematic diagram of at least one information display region of a display screen of an electronic device according to one embodiment of the present invention.

FIG. 2 is a schematic diagram of controlling a display screen of an electronic device according to one embodiment of the present invention.

FIG. 3 is a flow chart of a method for controlling information to display on a display screen according to one embodiment of the present invention.

### DETAILED DESCRIPTION OF PREFERRED EMBODIMENTS

The term “at least one” as used in the description, unless otherwise indicated, means one, two, three or more as described herein.

In one embodiment of the present invention, a method for controlling information display is provided, and particularly it is a method for controlling information display on a display screen of an electronic device. Firstly, the user continuously double clicks the display screen of the electronic device to enter a setting mode, and at least one information display region is set by pressing the display screen of the electronic device, and the user can further drag a border of the at least one information display area to adjust the border size and then hands off to complete the setting. Then, the user drags at least one different software types to different information display regions, and a storage is controlled by a controller to store one information in connection with the at least one software in the electronic device, so that the information in connection with the at least one software is displayed in the at least one information display regions. Finally, the user double clicks the display screen to finish the setting. When different information types in connection with the at least one software are received by the controller, the different information types of in connection with the at least one software are displayed at the at least one information display region on the display screen of the electronic device. Further, the display screen of the electronic device does not need to be displayed in a full screen mode. Therefore, power consumption can be reduced.

In one embodiment of the present invention, an area of the at least one information display region is less than an area of the display screen, and the area of the at least one information display region can be arbitrarily adjusted or constant. Specifically, the display screen of the electronic device comprises, but not limited to, one of an organic light-emitting diode and a light-emitting diode, the controller is a central processing unit, and the information type of the at least one software comprises, but not limited to a text message and a video message.

In one embodiment of the present invention, when different information types in connection with at least one software are received by a controller at the same time, the different information types in connection with the at least one software are simultaneously displayed at the information display regions of the display screen of the electronic device. In other words, the different information types in connection with software are displayed at the information display regions at the same time.

In one embodiment of the present invention, when different types of software information in connection with at least one software are received by a controller at different times, the different types of software information in connection with at least one software are displayed at the information display region of the display screen of the electronic device, respectively. In other words, the different types of software information in connection with at least one software are displayed at the information display region at different times.

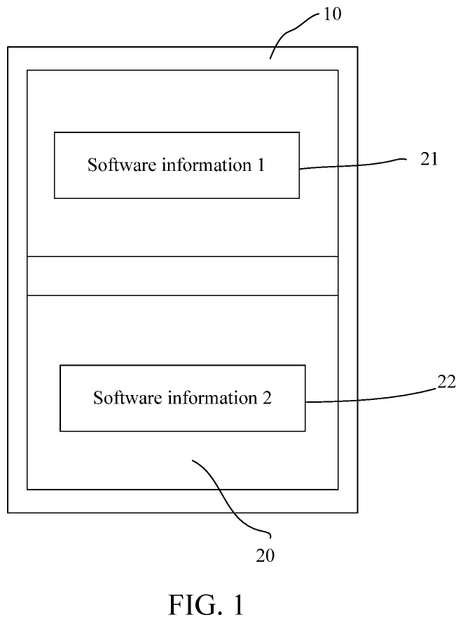

Referring to FIG. 1, it is a schematic diagram of at least one information display region of a display screen of an electronic device according to one embodiment of the present invention. Specifically, the electronic device comprises one of a smart phone and a tablet computer. A terminal 10 comprises a display screen 20 and a controller. The display screen 20 can be a panel composed of organic light-emitting diodes. Also, the display screen 20 can be a panel composed of light-emitting diodes, and the controller can be a central processing unit. First, the display screen 20 is in a lock screen state, and then the electronic device receives software 1 information. Next, the controller controls the display screen 20 to display the software 1 information at a first information display region 21, and a second information display region 22 does not display. Moreover, when the display screen 20 is in a lock screen state, the electronic device receives software 2 information. Next, the controller controls the display screen 20 to display the software 2 information at the second information display region 22, and the first information display region 21 does not display. In addition, when the display screen 20 is in the lock screen state, the electronic device receives software information 1 and software information 2. Next, the controller controls the display screen 20 to simultaneously display the software information 1 at a first information display region 21 and the software information 2 at the second information display region 22. It is worth mentioning that the sum of the areas of the first information display area 21 and the second information display area 22 is less than or equal to the area of the display screen 20. The software information 1 and software information 2 are different software information types, for example, software information 1 is a text message, and software information 2 is video message, but is not limited thereof. The user can judge the software information types through a bright screen or a dark screen at different information display regions based on the prior setting of the software type, thereby power consumption can be reduced.

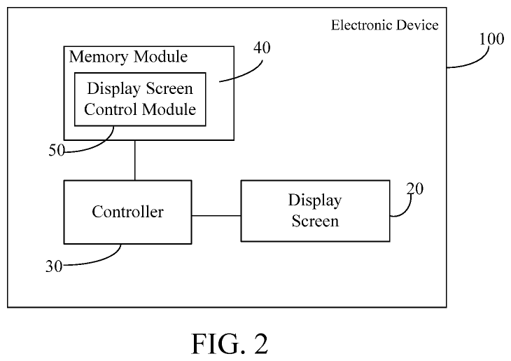

Referring to FIG. 2, it is a schematic diagram of an electronic device according to one embodiment of the present invention. The electronic device 100 according to the embodiment of the present invention comprises a memory module 40, a controller 30, and a display screen 20, and the memory module 40 includes a display screen control module 50, the controller 30 is a central processing unit, and the display screen 20 is composed of an organic light emitting diode. Also, the display panel 20 can also be a panel composed of light emitting diodes. When the electronic device 100 receives different software information types, a display screen control module 50 of the memory module 40 sends a signal to the controller 30, and then the controller 30 transmits a signal to the display screen 20 which is in a lock screen state. Finally, the display screen 20 displays different software information types at the at least one information display region. It should be noted that the display screen 20 does not need to be displayed in a full screen mode when software information is displayed, a border of at least one information display region can be adjusted, and an area of at least one information display region is less than the display screen. Further, the area of the information display region can be constant or not.

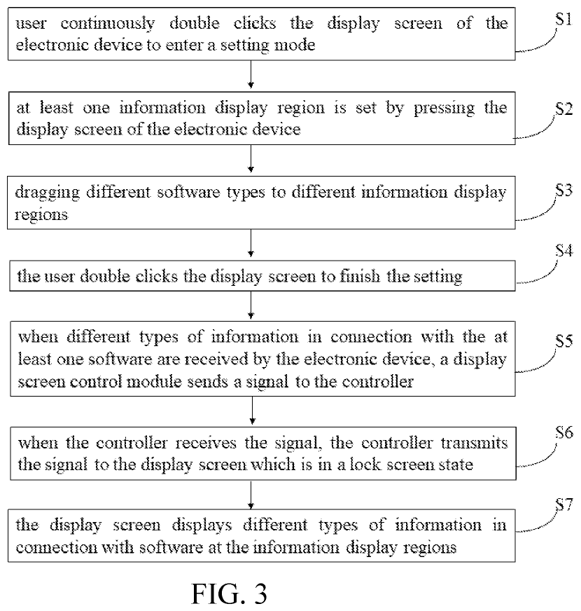

Referring to FIG. 3, it is a flow chart of a method for controlling information to display on a display screen according to one embodiment of the present invention. In particular, in one embodiment of the present invention, a method for controlling information display on a display screen of an electronic device is provide. First, in step S1, user continuous double clicks the display screen of the electronic device to enter a setting mode. In step S2, at least one information display region is set by pressing the display screen of the electronic device, and the user can further drag a border of the at least one information display area to adjust the border size and then hands off to complete the setting. In step S3, dragging different software types to different information display regions, and a controller controls a storage to store information in connection with the software, so that the information in connection with the software corresponds to each of the information display regions. In step S4, the user double clicks the display screen to finish the setting. In step S5, when different information types in connection with the at least one software are received by the electronic device, a display screen control module sends a signal to the controller. In step S6, when the controller receives the signal, the controller transmits the signal to the display screen which is in a lock screen state. In step S7, the display screen displays different information types in connection with software at the information display regions. In detail, when the electronic device does not receive any information, the display screen is in a lock screen state and the display screen is presented as a dark screen. Once the electronic device receives different information types of the at least one software such as social media messages and video messages, the different information types of the at least one software will be displayed at the information display regions the display screen of the electronic device. Meanwhile, the display screen of the electronic device does not need to be displayed in a full screen mode. Therefore, power consumption can be reduced. In addition, when the controller receives more than one pieces of information in connection with the at least one software at the same time, the pieces of information in connection with the at least one software are simultaneously displayed at the information display regions. When the electronic device receives more than one pieces of information in connection with at least one software at different times, the pieces of information in connection with the at least one software are displayed at the information display regions, respectively.

In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A method for controlling information display, the method comprising steps of:
setting at least one information display region on a display screen of an electronic device;
dragging at least one software to the at least one information display region;
storing one information type of the at least one software in the electronic device, wherein the information type of the at least one software corresponds to the at least one information display region;
receiving information in connection with the at least one software by a controller; and
displaying the information in connection with the at least one software at the at least one information display region.

2. The method for controlling information display according to claim 1, further comprising continuously double-clicking on the display screen of the electronic device to enter a setting mode.

3. The method for controlling information display according to claim 1, further comprising adjusting a frame of the at least one information display region.

4. The method for controlling information display according to claim 1, wherein an area of the at least one information display region is less than an area of the display screen of the electronic device.

5. The method for controlling information display according to claim 4, wherein the area of the at least one information display region is constant.

6. The method for controlling information display according to claim 4, wherein the area of the at least one information display region is adjustable.

7. The method for controlling information display according to claim 1, wherein the display screen of the electronic device comprises one of an organic light-emitting diode and a light-emitting diode.

8. The method for controlling information display according to claim 1, wherein the controller is a central processing unit.

9. The method for controlling information display according to claim 1, wherein the information type of the at least one software comprises one of a text message and a video message.

10. The method for controlling information display according to claim 1, wherein there are more than one pieces of information and more than one information display regions, and the pieces of information are simultaneously displayed at the information display regions, respectively, at the same time.

11. The method for controlling information display according to claim 1, wherein there are more than one pieces of information and more than one information display regions, and the pieces of information are displayed at the information display regions, respectively, at different times.

12. An electronic device for displaying information, comprising:
a display screen, wherein at least one information display region is set on the display screen, and at least one software is dragged to the at least one information display region; and
a controller, wherein information in connection with the at least one software is received by the controller, and the information in connection with the at least one software is displayed at the at least one information display region.

13. The electronic device for displaying information according to claim 12, further comprising continuously double-clicking on the display screen of the electronic device to enter a setting mode.

14. The electronic device for displaying information according to claim 12, wherein an area of the at least one information display region is less than an area of the display screen of the electronic device.

15. The electronic device for displaying information according to claim 12, wherein the area of the at least one information display region is constant.

16. The electronic device for displaying information according to claim 12, wherein the area of the at least one information display region is adjustable.

17. The electronic device for displaying information according to claim 12, wherein the display screen of the electronic device comprises one of an organic light-emitting diode and a light-emitting diode.

18. The electronic device for displaying information according to claim 12, wherein the information type of the at least one software comprises one of a text message and a video message.

19. The electronic device for displaying information according to claim 12, wherein there are more than one pieces of information and more than one information display regions, and the pieces of information are simultaneously displayed at the information display regions, respectively, at the same time.

20. The electronic device for displaying information according to claim 12, wherein there are more than one pieces of information and more than one information display regions, and the pieces of information are displayed at the information display regions, respectively, at different times.
